(19) United States
(12) Patent Application Publication
(10) Pub. No.: US 2014/0295294 A1
(43) Pub. Date: Oct. 2, 2014

(54) LITHIUM AIR BATTERY AND LITHIUM ION SECONDARY BATTERY

(71) Applicant: HONDA MOTOR CO., LTD., TOKYO (JP)

(72) Inventor: Mahito CHIBA, Wako-shi (JP)

(73) Assignee: HONDA MOTOR CO., LTD., TOKYO (JP)

(21) Appl. No.: 14/225,522

(22) Filed: Mar. 26, 2014

(30) Foreign Application Priority Data
Mar. 28, 2013 (JP) 2013-070606
Mar. 20, 2014 (JP) 2014-058975

(51) Int. Cl. H01M 12/08

(52) U.S. Cl. CPC H01M 12/08; H01M 2300/0034
USPC 429/405

(57) ABSTRACT

A lithium air battery 1 includes: a cathode 11 in which oxygen is used as a cathode active material; an anode 12 that has an anode active material capable of storing and releasing lithium ions; and an electrolytic solution that is held between the cathode 11 and the anode 12, in which the electrolytic solution includes a solvent represented by the following formula (1):

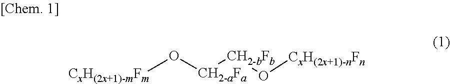

(wherein x represents an integer of 1 to 3; m and n each independently represent an integer of 1 to 2x+1, a and b each independently represent an integer of 0 to 2, and m+n+a+b≧3).

### BACKGROUND OF THE INVENTION

1. Field of the Invention

The present invention relates to a lithium air battery and a lithium ion secondary battery.

2. Description of Related Art

Recently, improvement in the performance of a storage battery used in an electric vehicle or a plug-in hybrid electric vehicle (PHEV) has been actively studied. As such a storage battery, for example, a lithium ion secondary battery (for example, refer to Japanese Unexamined Patent Application, First Publication No. 2010-238510) has been put into practical use, and a lithium air battery (for example, refer to Japanese Unexamined Patent Application, First Publication No. 2012-227119 and Japanese Unexamined Patent Application, First Publication No. 2009-32415) having an extremely high energy density which is 5 or more times that of a lithium ion secondary battery has attracted attention as a next-generation storage battery.

### SUMMARY OF THE INVENTION

### Technical Problem

As a problem which is common to a lithium air battery and a lithium ion secondary battery, decomposition of an electrolytic solution in or near an electrode can be exemplified. It is known that such decomposition of an electrolytic solution occurs when a solvent contained in the electrolytic solution is electrically oxidized or reduced during charging or discharging.

When an electrolytic solution is decomposed during charging or discharging, various kinds of gases which are decomposition products are produced, and deterioration in capacity, the swelling of a battery pack, or the like occurs, which results in various types of deterioration in performance.

Further, in a lithium air battery, since an active material of a cathode (air electrode) is oxygen, O₂⁻ radicals as a strong nucleophilic agent are produced during discharging. Therefore, in an electrolytic solution of a lithium air battery, stronger reduction resistance than that of a lithium secondary battery is required.

In order to solve the problems, a technique of suppressing decomposition of an electrolytic solution depending on operating conditions during the discharging and charging of a lithium air battery and a lithium ion secondary battery has been studied, but further improvement thereof is required.

The present invention has been made in consideration of the above-described circumstances, and an object thereof is to provide a lithium air battery and a lithium ion secondary battery including an electrolytic solution in which decomposition depending on operating conditions during discharging and charging is suppressed.

### Solution to Problem

In order to solve the above-described problems, according to an aspect of the present invention, there is provided the followings.

[1] A lithium air battery (for example, a lithium air battery 1 in an embodiment of the present invention) including: a cathode (for example, a cathode 11 in the embodiment) in which oxygen is used as a cathode active material; an anode (for example, an anode 12 in the embodiment) that has an anode active material capable of storing and releasing lithium ions; and an electrolytic solution (for example, an electrolytic solution with which a separator 13 is impregnated in the embodiment) that is held between the cathode and the anode, in which the electrolytic solution includes a solvent represented by the following formula (1):

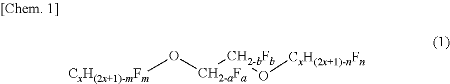

(wherein x represents an integer of 1 to 3; m and n each independently represent an integer of 1 to 2x+1, a and b each independently represent an integer of 0 to 2, and m+n+a+b≧3).

[2] The lithium air battery according to the above [1], wherein in the formula (1), the numbers of fluorine atoms binding to carbon atoms at both molecular terminals each independently be 2 or 3.

[3] The lithium air battery according to the above [1] or [2], wherein in the formula (1), m+n+a+b≧6.

[4] A lithium ion secondary battery (for example, a lithium ion secondary battery 2 in an embodiment of the present invention) including: a cathode (for example, a cathode 21 in the embodiment) that has a cathode active material capable of storing and releasing lithium ions; an anode (for example, an anode 22 in the embodiment) that has an anode active material capable of storing and releasing lithium ions; and an electrolytic solution (for example, an electrolytic solution with which a separator 23 is impregnated in the embodiment) that is held between the cathode and the anode, in which the electrolytic solution includes a solvent represented by the following formula (1):

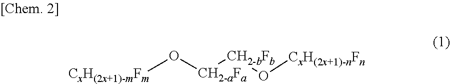

(wherein x represents an integer of 1 to 3; m and n each independently represent an integer of 1 to 2x+1, a and b each independently represent an integer of 0 to 2, and m+n+a+b≧3).

[5] The lithium ion secondary battery according to the above [4], wherein in the formula (1), the numbers of fluorine atoms binding to carbon atoms at both molecular terminals each independently be 2 or 3.

[6] The lithium ion secondary battery according to the above [4] or [5], wherein in the formula (1), m+n+a+b≧6.

### Advantageous Effects of Invention

Since the lithium air battery according to the above [1] includes the electrolytic solution in which decomposition depending on operating conditions during discharging and charging is suppressed, the lithium air battery having superior cycle characteristics and high reliability can be provided.

Since the lithium air battery according to the above [2] or [3] includes the electrolytic solution in which the solvent having superior oxidation resistance and reduction resistance is used, the lithium air battery having superior cycle characteristics and high reliability can be provided.

Since the lithium secondary ion battery according to the above [4] includes the electrolytic solution in which decomposition depending on operating conditions during discharging and charging is suppressed, a lithium secondary ion battery having superior cycle characteristics and high reliability can be provided.

Since the lithium secondary ion battery according to the above [5] or [6] includes the electrolytic solution in which the solvent having superior oxidation resistance and reduction resistance is used, a lithium secondary ion battery having superior cycle characteristics and high reliability can be provided.

### BRIEF DESCRIPTION OF THE DRAWINGS

FIG. 1 is a schematic diagram illustrating a lithium air battery according to a first embodiment of the present invention.

FIG. 2 is a schematic diagram illustrating a lithium ion secondary battery according to a second embodiment of the present invention.

### DETAILED DESCRIPTION OF THE INVENTION

### First Embodiment

Hereinafter, a lithium air battery according to a first embodiment of the present invention will be described with reference to the drawings. In all the drawings described below, the dimension, the ratio, and the like of each component are appropriately changed for easy understanding of the drawings.

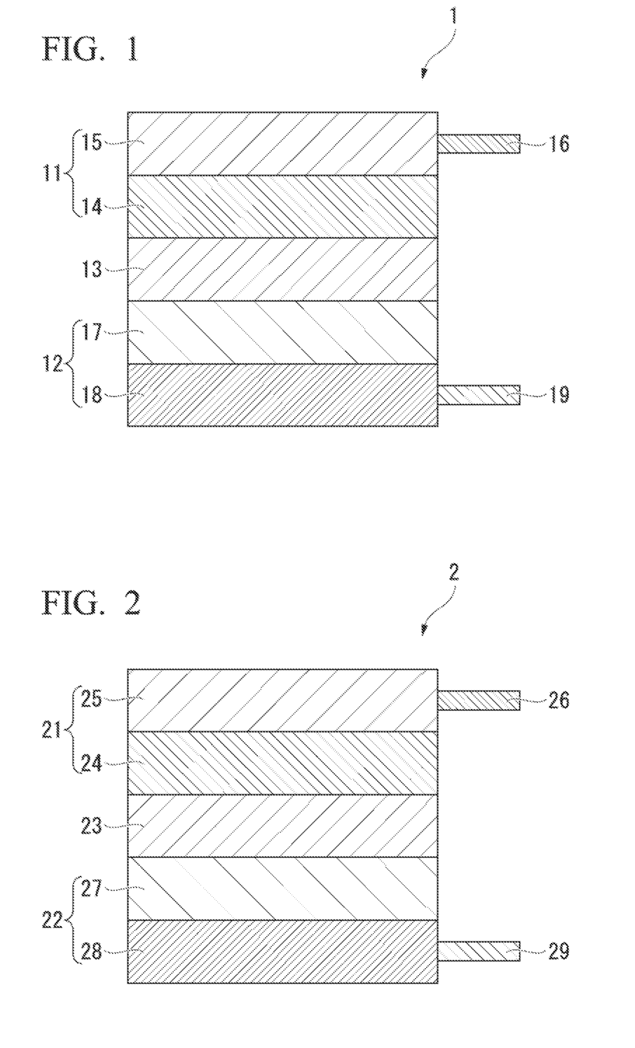

FIG. 1 is a schematic diagram illustrating the lithium air battery according to the embodiment. The lithium air battery 1 includes a cathode 11, an anode 12, a separator 13, and a housing (not illustrated) which accommodates the above-described components. The separator 13 is impregnated with an electrolytic solution.

### (Cathode)

The cathode 11 includes a cathode catalyst layer 14 and a cathode current collector 15. The cathode catalyst layer 14 is a layer which functions as an active material by causing oxygen as a cathode active material to be incorporated thereinto. As a material used to form the cathode catalyst layer 14, porous carbon can be used.

The cathode current collector 15 is provided to be in contact with the cathode catalyst layer 14 and to be opposite the separator 13 with the cathode catalyst layer 14 interposed therebetween. In addition, a terminal 16 for electrical connection with an external configuration is connected to the cathode current collector 15. As a material used to form the cathode current collector 15, a metal material, carbon, or the like having conductivity can be used. The cathode current collector 15 may have a network shape or a lattice shape.

In addition, an oxygen diffusion film may be provided outside the cathode current collector 15 (side opposite the cathode catalyst layer 14). As the oxygen diffusion film, any film can be used as long as oxygen in the air preferably penetrates the film, and examples thereof include resin non-woven fabrics and porous films.

### (Anode)

The anode 12 includes an anode catalyst layer 17 and an anode current collector 18. The anode catalyst layer 17 is a layer containing an anode active material. As the anode active material, a material which is capable of storing and releasing lithium ions and is well-known as the anode active material can be used, and examples thereof include metal lithium.

The anode current collector 18 is provided to be in contact with the anode catalyst layer 17 and to be opposite the separator 13 with the anode catalyst layer 17 interposed therebetween. In addition, a terminal 19 for electrical connection with an external configuration is connected to the anode current collector 18. As a material used to form the anode current collector 18, the same material as that of the cathode current collector 15 can be used.

### (Separator)

The cathode catalyst layer 14 and the anode catalyst layer 17 are arranged opposite to each other. Between the cathode catalyst layer 14 and the anode catalyst layer 17, the separator 13 is arranged to be in contact with the cathode catalyst layer 14 and the anode catalyst layer 17. The separator 13 suppresses contact between the cathode and the anode and has a function of preventing short-circuiting.

As a material used to form the separator 13, an insulating material in which an electrolyte included in the electrolytic solution is movable can be used, and examples thereof include resin non-woven fabrics and porous films.

### (Electrolytic Solution)

The electrolytic solution with which the separator 13 is impregnated includes a solvent described below and the electrolyte that is dissolved in the solvent.

As the electrolyte, lithium salts which produce lithium ions when being dissolved in the solvent can be used. Examples of the electrolyte which is included in the electrolytic solution include ionic liquids such as LiClO₄, LiBF₄, or LiTFSI (Lithium Bis(Trifluoromethanesulfonyl)Imide).

In the lithium air battery according to the embodiment, as the solvent used in the electrolytic solution, a solvent represented by the following formula (1) is used.

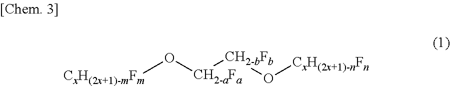

(wherein x represents an integer of 1 to 3; m and n each independently represent an integer of 1 to 2x+1, a and b each independently represent an integer of 0 to 2, and m+n+a+b≧3)

In a lithium air battery, since an active material of a cathode (air electrode) is oxygen, O₂⁻ radicals as a strong nucleophilic agent in the battery reaction are produced near the cathode. These O₂⁻ radicals reduce a solvent in an electrolytic solution near the cathode and are a main cause of deterioration. Accordingly, in the lithium air battery, in order to suppress decomposition depending on operating conditions during discharging and charging, high oxidation resistance as well as high reduction resistance are required.

The solvent represented by the formula (1) is substituted with fluorine atoms, and m+n+a+b≧3 is satisfied, that is, the number of fluorine atoms in one molecule is more than or equal to 3. Since the solvent is substituted with fluorine atoms, the highest occupied molecular orbital (HOMO) energy level E_{HOMO} defined by the frontier orbital theory is decreased, and it is difficult to release electrons. That is, solvent molecules are stabilized. Therefore, oxidation resistance is improved as compared to an unsubstituted diether.

In addition, the solvent represented by the formula (1) is a diether having two ether bonds (—C—O—C—) in the molecules.

When the number of ether bonds is 1, a molecular structure of the obtained compound is small. Therefore, it is considered that the electron state is unstable, and thus oxidation resistance and reduction resistance are decreased. In addition, when the number of ether bonds is more than 3, it is considered that a molecular orbital is expanded, and reduction resistance, in particular, is decreased. On the other hand, in the solvent represented by the formula (1), since the number of ether bonds is 2, oxidation resistance and reduction resistance are high.

In addition, in the solvent represented by the formula (1), the number of carbon atoms extending from an oxygen atom of an ether bond to a molecular terminal is an integer of 1 to 3. When the number of carbon atoms extending to the molecular terminal is more than 4, there is a concern that reduction resistance may be decreased along the expansion of the molecular orbital. However, in the solvent represented by the formula (1), such a decrease in reduction resistance is suppressed.

In addition, in the solvent represented by the formula (1), the numbers of carbon atoms at both terminals are the same, and thus a carbon skeleton has a symmetric property in a molecular structure except for hydrogen atoms and fluorine atoms. In the molecules having such a symmetric structure, the electron state of the molecular structure is stable as compared to molecules having an asymmetric carbon skeleton, and thus oxidation resistance, in particular, is high.

The electrolytic solution having such a solvent has high oxidation resistance and reduction resistance. Accordingly, in the lithium air battery according to the embodiment, decomposition depending on operating conditions during discharging and charging can be suppressed.

It is preferable that, in the solvent represented by the formula (1), the numbers of fluorine atoms binding to carbon atoms at both molecular terminals each independently be 2 or 3. With such a structure, a compound having high oxidation resistance and reduction resistance can be obtained, and a lithium air battery having high reliability can be provided.

It is preferable that, in the solvent represented by the formula (1), m+n+a+b≧6 be satisfied, that is, the number of fluorine atoms in one molecule be more than or equal to 6. With such a structure, a compound having high oxidation resistance and reduction resistance can be obtained, and a lithium air battery having high reliability can be provided.

### (Evaluation of Oxidation Resistance and Reduction Resistance)

The oxidation resistance and the reduction resistance of the solvent represented by the above formula (1) may be evaluated by actually assembling a cell of a lithium air battery and measuring cycle characteristics and the amount of gas produced, but may also be evaluated by the following theoretical calculation.

That is, regarding the oxidation resistance and the reduction resistance which is the problem of an electrolytic solution of the related art, when the acceptance and release of electrons in the oxidation reaction and the reduction reaction are focused, the reduction reaction is a reaction of accepting electrons from the outside, and the oxidation reaction is a reaction of releasing electrons to the outside. That is, the oxidation reaction and the reduction reaction can be replaced with the reaction of accepting and releasing electrons.

In a solvent molecule, when a highest occupied molecular orbital (HOMO) energy level E_{HOMO} and a lowest occupied molecular orbital (HOMO) energy level E_{LUMO} which are defined by the frontier orbital theory are considered, the following relationship can be satisfied between a potential during discharging and charging and E_{HOMO} and E_{LUMO} of the electrolytic solution (solvent).

That is, in a solvent molecule, when the potential during charging is higher than or equal to E_{LUMO}, it can be said that the reduction reaction (reaction of accepting electrons) is caused in this electrolytic solution.

On the other hand, when the potential during discharging is lower than or equal to E_{HOMO}, it can be said that the oxidation reaction (reaction of releasing electrons) is caused in this electrolytic solution.

Based on this thought, when a solvent molecule has high E_{LUMO}, it can be evaluated that it is difficult to accept electrons, and reduction resistance is high.

When a solvent molecule has low E_{HOMO}, it can be evaluated that it is difficult to discharge electrons, and oxidation resistance is high.

In the present invention, E_{LUMO} and E_{HOMO} of a solvent molecule are calculated using the long-range-corrected density functional theory (LC-DFT) which is the first principle method described in a known document (J. Chem. Phys. 133, 174101 (2010)). In the calculation, LC-BOP is used as a density functional, and cc-pVDZ is used as a basis function. By the above method, E_{LUMO} and E_{HOMO} of a solvent molecule can be calculated with accuracy.

When the solvent represented by the above formula (1) is evaluated based on E_{LUMO} and E_{HOMO} obtained by the above-described calculation, it can be evaluated that the oxidation resistance and the reduction resistance of the solvent represented by the above formula (1) are higher than those of an ester compound and an ether compound which are widely used in a lithium ion secondary battery of the related art.

According to the lithium air battery having the above-described configuration, since the electrolytic solution includes the solvent represented by the above formula (1), decomposition depending on operating conditions during discharging and charging is suppressed.

### Second Embodiment

FIG. 2 is a diagram illustrating a lithium ion secondary battery according to a second embodiment of the present invention.

As illustrated in FIG. 2, the lithium ion secondary battery 2 according to the embodiment includes a cathode 21, an anode 22, a separator 23, and a housing (not illustrated) for accommodating the above-described components. The separator 23 is impregnated with an electrolytic solution.

### (Cathode)

The cathode 21 includes a cathode catalyst layer 24 and a cathode current collector 25. The cathode catalyst layer 24 is a layer containing a cathode active material. As the cathode active material, a material which is capable of storing and releasing lithium ions and is generally known as the cathode active material can be used, and examples thereof include lithium cobaltate which is a lithium composite metal oxide.

The cathode current collector 25 is provided to be in contact with the cathode catalyst layer 24 and to be opposite the separator 23 with the cathode catalyst layer 24 interposed therebetween. In addition, a terminal 26 for electrical connection with an external configuration is connected to the cathode current collector 25. The cathode current collector 25 can adopt the same configuration as that of the above-mentioned first embodiment.

### (Anode)

The anode 22 includes an anode catalyst layer 27 and an anode current collector 28. The anode catalyst layer 27 is a layer containing an anode active material. As the anode active material, a material which is capable of storing and releasing lithium ions at a potential lower than that of the cathode and is generally known as the anode active material can be used, and examples thereof include graphite.

The anode current collector 28 is provided to be in contact with the anode catalyst layer 27 and to be opposite the separator 23 with the anode catalyst layer 27 interposed therebetween. In addition, a terminal 29 for electrical connection with an external configuration is connected to the anode current collector 28. As a forming material of the anode current collector 28, the same material as that of the cathode current collector 25 can be used.

### (Separator and Electrolytic Solution)

The cathode catalyst layer 24 and the anode catalyst layer 27 are arranged opposite to each other. Between the cathode catalyst layer 24 and the anode catalyst layer 27, the separator 23 is arranged to be in contact with the cathode catalyst layer 24 and the anode catalyst layer 27. The separator 23 can adopt the same configuration as that of the above-mentioned first embodiment.

### (Electrolytic Solution)

The separator 23 is impregnated with the electrolytic solution. The electrolytic solution can adopt the same configuration as that of the above-mentioned first embodiment and includes a solvent represented by the following formula (1) and a lithium salt as an electrolyte that is dissolved in the solvent.

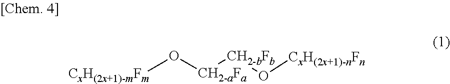

(wherein x represents an integer of 1 to 3; m and n each independently represent an integer of 1 to 2x+1, a and b each independently represent an integer of 0 to 2, and m+n+a+b≧3)

The electrolytic solution having such a solvent has high oxidation resistance and reduction resistance. Therefore, similarly to the case of the lithium air battery according to the first embodiment, decomposition can also be suppressed during the discharging and charging of the lithium ion secondary battery.

It is preferable that, in the solvent represented by the above formula (1), the numbers of fluorine atoms binding to carbon atoms at both molecular terminals each independently be 2 or 3. With such a structure, a compound having higher oxidation resistance and reduction resistance can be obtained, and a lithium ion secondary battery having high reliability can be provided.

It is preferable that, in the solvent represented by the above formula (1), m+n+a+b≧6 be satisfied, that is, the number of fluorine atoms in one molecule be more than or equal to 6. With such a structure, a compound having higher oxidation resistance and reduction resistance can be obtained, and a lithium ion secondary battery having high reliability can be provided.

According to the lithium ion secondary battery having the above-described configuration, since the electrolytic solution includes the solvent represented by the above formula (1), decomposition depending on operating conditions during discharging and charging is suppressed.

While preferred embodiments of the invention have been described and illustrated above with reference to the appended drawings, it is needless to say that the present invention is not limited to these embodiments. The shape, the combination, and the like of each component described in the above-described embodiment are merely exemplary, and various modifications can be made based on design requirements and the like within a range not departing from the spirit or scope of the present invention.

### EXAMPLES

Hereinafter, the present invention will be described using examples but is not limited to these examples.

### (1. Energy Level Calculation of Solvent Molecule)

In the examples, E_{LUMO} and E_{HOMO} of a solvent molecule was calculated using the long-range-corrected density functional theory (LC-DFT) which is the first principle method described in J. Chem. Phys. 133, 174101 (2010). In the calculation, LC-BOP was used as a density functional, and cc-pVDZ was used as a basis function.

Using the above calculation method, energy levels of solvent molecules of the following Examples 1 to 5, Reference Examples 1 and 2, and Comparative Examples 1 to 9 were calculated, and E_{LUMO} and E_{HOMO} of the respective solvent molecules were compared to each other.

### Example 1

A compound represented by the following formula (2): wherein the number of carbon atoms extending from an oxygen atom of an ether bond to a molecular terminal is 1 (x=1 in the above formula (1)), and the numbers of fluorine atoms binding to carbon atoms at both terminals each independently are 2 (m, n=2 in the above formula (1)).

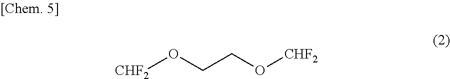

### Example 2

A compound represented by the following formula (3): wherein the number of carbon atoms extending from an oxygen atom of an ether bond to a molecular terminal is 1, and the numbers of fluorine atoms binding to carbon atoms at both terminals are each independently 3 (m, n=3 in the above formula (1)).

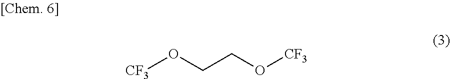 [SMILES: FC(F)(F)OCCOC(F)(F)F]

### Example 3

A compound represented by the following formula (4): wherein the number of carbon atoms extending from an oxygen atom of an ether bond to a molecular terminal is 2 (x=2 in the above formula (1)), and the numbers of fluorine atoms binding to carbon atoms at both terminals are each independently 3.

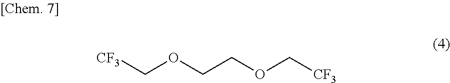 [SMILES: FC(F)(F)COCCOCC(F)(F)F]

### Example 4

A compound represented by the following formula (5): wherein the number of carbon atoms extending from an oxygen atom of an ether bond to a molecular terminal is 3 (x=3 in the above formula (1)), and the numbers of fluorine atoms binding to carbon atoms at both terminals are each independently 3.

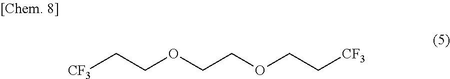 [SMILES: FC(F)(F)CCOCCOCCC(F)(F)F]

### Example 5

A compound represented by the following formula (6): wherein the number of carbon atoms extending from an oxygen atom of an ether bond to a molecular terminal is 1, the number of fluorine atoms binding to a carbon atom at one of both terminals is 3 (m=3 in the above formula (1)), and the number of fluorine atoms binding to a carbon atom at the other terminal is 2 (n=2 in the above formula (1)). Further, b=1 in the above formula (1).

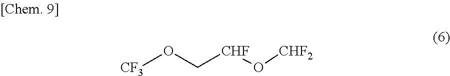

### Reference Example 1

Ethylene carbonate represented by the following formula (7).

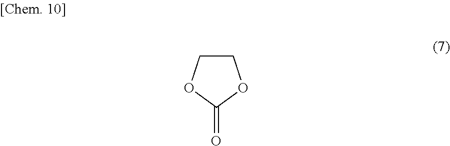

### Reference Example 2

Diethyl carbonate represented by the following formula (8).

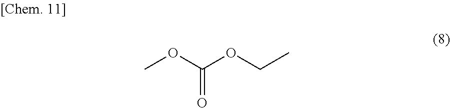

### Comparative Example 1

An unsubstituted dimethoxy ethane represented by the following formula (9). In the above formula (1), a compound in which x=1, and m, n, a, b=0.

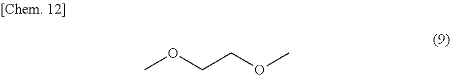

### Comparative Example 2

A compound represented by the following formula (10): wherein the number of carbon atoms extending from an oxygen atom of an ether bond to a molecular terminal is 1 (x=1 in the above formula (1)), and the numbers of fluorine atoms binding to carbon atoms at both terminals are each independently 1 (m, n=1 in the above formula (1)).

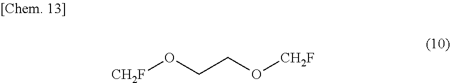

### Comparative Example 3

A fluorinated monoether represented by the following formula (11): wherein the number of oxygen atoms in an ether bond is 1, the number of carbon atoms extending from the ether bond to a molecular terminal is 1, and the numbers of fluorine atoms binding to carbon atoms at both terminals are each independently 3.

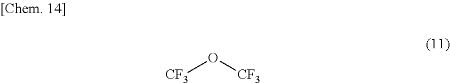

### Comparative Example 4

A fluorinated triether represented by the following formula (12): wherein the number of oxygen atoms in ether bonds is 3, the number of carbon atoms extending from an ether bond to a molecular terminal is 1, and the numbers of fluorine atoms binding to carbon atoms at both terminals are each independently 3.

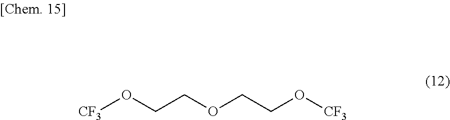 [SMILES: FC(F)(F)OCCOCCOC(F)(F)F]

### Comparative Example 5

A fluorinated tetraether represented by the following formula (13): wherein the number of oxygen atoms in ether bonds is 4, the number of carbon atoms extending from an ether bond to a molecular terminal is 1, and the numbers of fluorine atoms binding to carbon atoms at both terminals are each independently 3.

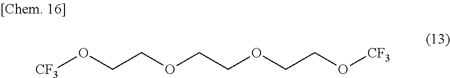 [SMILES: FC(F)(F)OCCOCCOCCOC(F)(F)F]

### Comparative Example 6

A compound represented by the following formula (14): wherein the number of carbon atoms extending from an oxygen atom of an ether bond to a molecular terminal is 4 (x=4 in the above formula (1)), and the numbers of fluorine atoms binding to carbon atoms at both terminals are each independently 3.

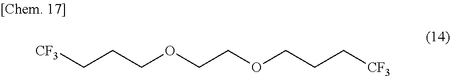 [SMILES: FC(F)(F)CCCOCCOCCCC(F)(F)F]

### Comparative Example 7

A compound represented by the following formula (15): wherein the number of carbon atoms extending from an oxygen atom of an ether bond to a molecular terminal is 5 (x=5 in the above formula (1)), and the numbers of fluorine atoms binding to carbon atoms at both terminals are each independently 3.

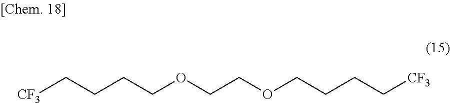 [SMILES: FC(F)(F)CCCCOCCOCCCCC(F)(F)F]

### Comparative Example 8

A compound represented by the following formula (16): wherein the number of carbon atoms extending from an oxygen atom of an ether bond to a molecular terminal is 1 (x=1 in the above formula (1)), the number of fluorine atoms binding to a carbon atom at one of both terminals is 3 (m=3 in the above formula (1)), and the number of fluorine atoms binding to a carbon atom at the other terminal is 0 (n=0 in the above formula (1)).

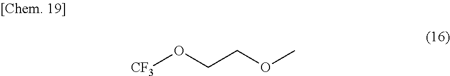

### Comparative Example 9

A compound represented by the following formula (17): wherein the number of carbon atoms extending from an oxygen atom of an ether bond to a molecular terminal is 2 (x=2 in the above formula (1)), the number of fluorine atoms binding to carbon atoms at one of both terminals is 3 (m=3 in the above formula (1)), and the number of fluorine atoms binding to carbon atoms at the other terminal is 0 (n=0 in the above formula (1)).

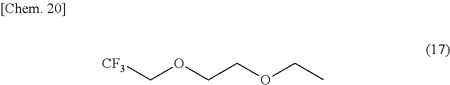

### (Synthesis Method)

A solvent having a molecular structure of any one of Examples 1 to 5 can be synthesized according to the following formulae (18) and (19).

[Chem. 21]

RfOH+NaH→RfO⁻

RfO⁻+CF₃SO₂Cl→RfOSO₂CF₃ (18)

(wherein Rf represents an alkyl group having 1 to 3 carbon atoms substituted with fluorine)

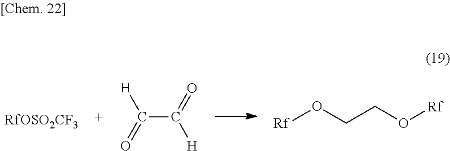

First, as illustrated in the formula (18), a fluorinated alcohol is reduced with a sodium hydride and is caused to react with sulfonic acid halide. As a result, a sulfonic acid ester is obtained.

Next, as illustrated in the formula (19), the obtained sulfonic acid ester and a glyoxal are caused to react with each other in an aprotic polar solvent in the presence of a hydride, for example, an alkali metal hydride such as LiH, NaH, KH, RbH, or CsH. As a result, a desired diether is obtained.

As long as the desired compound is obtained, the synthesis method is not limited to the above-described method, and any synthesis method can be adopted.

For example, the compound of Example 3 represented by the above formula (4) can be synthesized according to the following formula (20) with reference to a known document (Anal. Chem. 1982, 54, 529-533)

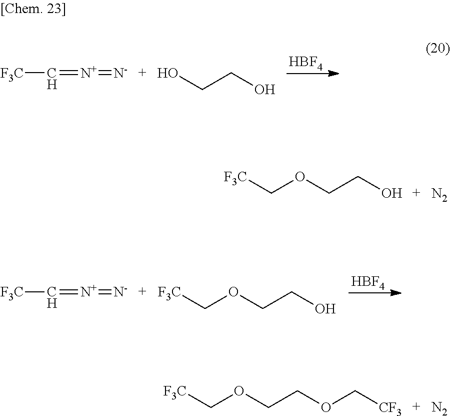

That is, as illustrated in the formula (20), a diazo compound having a fluorinated alkyl group (2,2,2-trifluorodiazoethane) is caused to react with an ethylene glycol in the presence of a catalytic amount of HBF₄. As a result, two hydrogen groups included in the ethylene glycol react with the diazo compound in stages, and thus a desired diether is obtained.

Using the same method, the diazo compound is changed into 3,3,3-trifluorodiazopropane. As a result, the compound of Example 4 represented by the above formula (5) can be synthesized.

Regarding Examples 1 to 5, Reference Examples 1 and 2, and Comparative Examples 1 to 9, the calculation results of E_{LUMO} and E_{HOMO} are shown in Table 1.

TABLE 1

| | Example 1 | Example 2 | Example 3 | Example 4 | Example 5 |
|---|---|---|---|---|---|
| LUMO | 3.88 | 3.93 | 3.83 | 3.51 | 3.92 |
| HOMO | −10.97 | −11.61 | −11.42 | −11.35 | −11.55 |

| | Reference | Reference | Comparative | Comparative | Comparative | Comparative | Comparative |
|---|---|---|---|---|---|---|---|
| | Example 1 | Example 2 | Example 1 | Example 2 | Example 3 | Example 4 | Example 5 |
| LUMO | 3.43 | 3.79 | 4.08 | 3.77 | 3.45 | 3.61 | 3.61 |
| HOMO | −10.49 | −10.23 | −9.30 | −9.95 | −10.22 | −9.94 | −9.75 |

| | Reference Example 6 | Reference Example 7 | Reference Example 8 | Reference Example 9 |
|---|---|---|---|---|
| LUMO | 3.01 | 2.90 | 3.74 | 3.71 |
| HOMO | −11.50 | −11.47 | −9.80 | −9.56 |

It is generally known that the ethylene carbonate of Reference Example 1 is inadequate in both oxidation resistance and reduction resistance. In addition, it is known that the diethyl carbonate of Reference Example 2 shows good reduction resistance, but is inadequate in oxidation resistance. Furthermore, it is known that the dimethoxy ethane of Comparative Example 1 shows good reduction resistance, but has extremely-poor oxidation resistance. Based on the above knowledge, referring to the calculation results of the above Table 1, the following was found. It is required from the aspect of reduction resistance that E_{LUMO} of a solvent used in an electrolytic solution is higher than 3.43 (Reference Example 1, and it is required from the aspect of oxidation resistance that E_{HOMO} of a solvent used in an electrolytic solution is lower than −10.49 (Reference Example 1.

In addition, it was found from Examples 1 and 2 and Comparative Examples 1 and 2 that, as the numbers of fluorine atoms included in carbon atoms at both terminals are increased, E_{HOMO} is decreased, and thus oxidation resistance is improved. In addition, it was found that the compounds of Examples 2 and 3 have high reduction resistance and oxidation resistance.

It was found from Examples 2, 3, and 5 and Comparative Examples 8 and 9 that, when fluorine atoms bind to carbon atoms at both molecular terminals, high reduction resistance and oxidation resistance are obtained.

It was found from Example 2 and Comparative Examples 3 to 5 that, when the number of ether bonds is 2, high reduction resistance and oxidation resistance are obtained.

It was found from Examples 2 to 4 and Comparative Examples 6 and 7 that, when the number of carbon atoms extending from an oxygen atom of an ether bond to a molecular terminal is 1 to 3, high reduction resistance and oxidation resistance are obtained.

(2. Analysis of Produced Gas Component after Discharging and Charging Test)

### Reference Example 3

### After the Discharging and Charging Gas Analysis Test 1

After the discharging and charging gas analysis test, gas analysis was performed during charging using a mixed solvent of ethylene carbonate (C₃H₄O₃) and diethyl carbonate (C₄H₈O₃) which are used as an organic solvent for an electrolytic solution of a lithium ion secondary battery of the related art, the ethylene carbonate being a cyclic carbonate and the diethyl carbonate being a chain carbonate.

In order to prepare an electrolytic solution, 1 mol/L of lithium bis(trifluoromethanesulfonyl)imide (LiTFSI) was dissolved in the mixed solution of ethylene carbonate and diethyl carbonate (3:7).

In an air battery cell capable of gas filling, carbon (ketjen black) was used for a cathode and metal lithium was used for an anode, and the electrolytic solution prepared as above was filled to assemble an air battery cell. At this time, in the air battery cell, O₂ as a cathode active material and Ar as atmosphere gas were filled.

Discharging and Charging were performed using the following methods.

First, a voltage was applied to the prepared air battery cell until an open circuit voltage (OCV) was reached, and then the air battery cell was held at the open circuit voltage for 1 hour. Next, the air battery cell was discharged to 2.4 V at a discharging rate of 0.176 mA (99.6 μA/cm²) and was charged to 4.6 V at a charging rate of 0.352 mA (199.2 μA/cm²).

After charging, gas components in the cell were collected with a gas-tight syringe. Then, using gas chromatography, a ratio of gas components, which were produced by the decomposition of the solvent during discharging and charging, to all the gas components in the cell was analyzed.

### Comparative Example 10

### After the Discharging and Charging Gas Analysis Test 2

The same test as that of the above after the discharging and charging gas analysis test 1 was performed, except that the solvent of the electrolytic solution was changed to dimethoxy ethane (=methyl monoglyme; DME; C₄H₁₀O₂) which is a chain ether. After charging, the gas components in the cell were analyzed.

### Example 6

### After the Discharging and Charging Gas Analysis Test 3

The same test as that of the above after the discharging and charging gas analysis test 1 was performed, except that the solvent of the electrolytic solution was changed to the compound of Example 3 represented by the above formula (4). After charging, the gas components in the cell were analyzed. The compound represented by the formula (4) was synthesized according to the above formula (20).

The results of the after discharging and charging gas analysis tests 1 to 3 are shown in Table 2. Among gaseous species produced after the discharging and charging tests, CO₂ is gas produced by the decomposition of Li₂CO₃ during charging, wherein said Li₂CO₃ is produced by the reductive decomposition during discharging.

TABLE 2

| | Gas Amount (%) | | |
|---|---|---|---|
| | Discharging | Discharging | |
| | and Charging | and Charging | |
| | Test 1 | Test 2 | Discharging and Charging |
| Gaseous | (Reference | (Comparative | Test 3 |
| Species | Example 3) | Example 10) | (Example 6) |
| CO₂ | 7.6 | <1 | <1 |

In Reference Example 3 (the mixed solvent of ethylene carbonate and diethyl carbonate), CO₂ caused by the reductive decomposition during discharging was found.

In Comparative Example 10 (dimethoxy ethane), CO₂ was not found.

It can be said based on the above results that the mixed solution of ethylene carbonate and diethyl carbonate is unstable to the reduction reaction. On the other hand, it can be said that the dimethoxy ethane is superior in reduction reaction resistance.

In addition, it can be said based on the calculation results of E_{HOMO} in Table 1 that the mixed solution of ethylene carbonate and diethyl carbonate is unstable to the oxidation reaction. On the other hand, it can be said that the dimethoxy ethane is poorer than a carbonate-based solvent in oxidation reaction resistance.

On the other hand, it can be said based on the result in Table 1 that the compound represented by the formula (4) is superior in oxidation reaction resistance. It is thought that this resistance is caused by the structure that methyl groups at both terminals are substituted with fluorine and caused by the symmetric structure.

In addition, it can be said based on the results in Tables 1 and 2 that the compound represented by the formula (4) is superior in reduction reaction resistance. It is thought that this resistance is caused by the structure that the number of carbon atoms extending to the molecular terminal is 2 which diminishes the expansion of the molecular orbital, and is caused by the structure derived from a diether.

From the above results, the usefulness of the present invention can be confirmed.

### INDUSTRIAL APPLICABILITY

It is possible to provide a lithium air battery and a lithium ion secondary battery including an electrolytic solution in which decomposition depending on operating conditions during discharging and charging is suppressed.

### REFERENCE SIGNS LIST

1 Lithium air battery
2 Lithium ion secondary battery
11 Cathode
12 Anode
21 Cathode
22 Anode

What is claimed is:

1. A lithium air battery comprising:
a cathode in which oxygen is used as a cathode active material;
an anode that has an anode active material capable of storing and releasing lithium ions; and
an electrolytic solution that is held between the cathode and the anode,
wherein the electrolytic solution includes a solvent represented by the following formula (1): 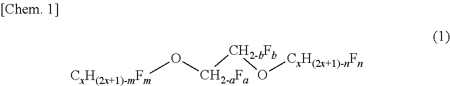
(wherein x represents an integer of 1 to 3; m and n each independently represent an integer of 1 to 2x+1, a and b each independently represent an integer of 0 to 2, and m+n+a+b≧3).

2. The lithium air battery according to claim 1,
wherein in the formula (1), the numbers of fluorine atoms binding to carbon atoms at both molecular terminals is each independently 2 or 3.

3. The lithium air battery according to claim 1,
wherein in the formula (1), m+n+a+b≧6.

4. A lithium ion secondary battery comprising:
a cathode that has a cathode active material capable of storing and releasing lithium ions;
an anode that has an anode active material capable of storing and releasing lithium ions; and
an electrolytic solution that is held between the cathode and the anode,
wherein the electrolytic solution includes a solvent represented by the following formula (1): 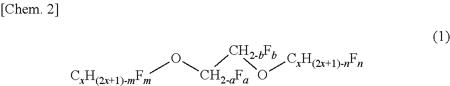
(wherein x represents an integer of 1 to 3; m and n each independently represent an integer of 1 to 2x+1, a and b each independently represent an integer of 0 to 2, and m+n+a+b≧3).

5. The lithium ion secondary battery according to claim 4,
wherein in the formula (1), the numbers of fluorine atoms binding to carbon atoms at both molecular terminals is each independently 2 or 3.

6. The lithium ion secondary battery according to claim 4,
wherein in the formula (1), m+n+a+b≧6.

7. The lithium air battery according to claim 2,
wherein in the formula (1), m+n+a+b≧6.

8. The lithium ion secondary battery according to claim 5,
wherein in the formula (1), m+n+a+b≧6.
